(19) United States
(12) Patent Application Publication
(10) Pub. No.: US 2018/0307065 A1
(43) Pub. Date: Oct. 25, 2018

(54) Ultraviolet Curing Device

(71) Applicant: Wuhan China Star Optoelectronics Technology Co., Ltd., Wuhan (CN)

(72) Inventor: Mingliang Wang, Wuhan (CN)

(73) Assignee: Wuhan China Star Optoelectronics Technology Co., Ltd., Wuhan, HB (CN)

(21) Appl. No.: 15/571,380

(22) PCT Filed: May 18, 2017
(86) PCT No.: PCT/CN2017/084855

§ 371 Date: Nov. 2, 2017

(30) Foreign Application Priority Data
Apr. 14, 2017 (CN) 201710248123.0

(51) Int. Cl. G02F 1/13; G02F 1/1333; G02B 19/00

(52) U.S. Cl. CPC G02F 1/1303; G02B 19/0095; G02B 19/0019; G02F 1/133308

(57) ABSTRACT

An ultraviolet curing device is proposed, which includes a sample stage and a curing module. The curing module is configured to emit ultraviolet rays to make the ultraviolet rays irradiate a to-be-cured display panel at a specific angle. The curing module includes a first curing module and a second curing module, and the first curing module and the second curing module are disposed symmetrically to each other.

### TECHNICAL FIELD OF THE DISCLOSURE

The present disclosure relates to display technology, and more particularly, to an ultraviolet curing device.

### BACKGROUND OF THE DISCLOSURE

In the existing skills, a liquid crystal infusion technique is usually adopted in pouring liquid crystal molecules into cells for large-scale display panels. Such a technique is first to drop a liquid crystal material onto the surface of a lower glass substrate. A glue dispenser machine is then utilized to apply a frame sealing glue with ultraviolet irradiation. Next, the lower glass substrate is placed in a vacuum environment, and then is aligned with and attached to an upper glass substrate, and a curing operation is performed therebetween. In this way, packaging the cells of the display panels is accomplished.

Currently, curing the frame sealing glue is usually carried out using an ultraviolet curing device. An existing ultraviolet curing device is equipped with only one-way irradiation in performing a curing operation. That is, the ultraviolet rays generated by the existing ultraviolet curing device only can irradiate downward directly. This way leads to a bad curing effect for the edge of the display panel. This may cause overflow if the glue on the edge is not cured completely. As a result, the quality of the display panel is affected.

In addition, it also requires the ultraviolet curing device in attaching the display panel to a cover plate. This may cause same problems as described above. Especially in attaching a flexible display panel to the cover plate, the curing at a curved portion of the flexible display panel is affected by the angle a light source is aimed at, thereby causing the curing unevenly.

Therefore, there is a need to provide an ultraviolet curing device in order to solve the problems in the existing skills.

### SUMMARY OF THE DISCLOSURE

The objective of the present disclosure is to provide an ultraviolet curing device, which can make ultraviolet rays reach a display panel at a specific angle, thereby carrying out high efficiency in irradiating the display panel at two sides thereof with the ultraviolet rays and improving the quality of the display panel.

The present disclosure provides an ultraviolet curing device, comprising: a sample stage configured to support and fix a to-be-cured display panel; and a curing module disposed above the sample stage and configured to emit ultraviolet rays to make the ultraviolet rays irradiate the to-be-cured display panel at a specific angle; wherein the curing module comprises a first curing module and a second curing module, and the first curing module and the second curing module are disposed symmetrically to cure the to-be-cured display panel at two sides thereof at the same time; wherein the curing module further comprises a control module connected to the first curing module and the second curing module and configured to control the first curing module and the second curing module to irradiate the to-be-cured display panel at the specific angles with the ultraviolet rays; wherein the curing module is configured to move along a specific path back and forth.

In the ultraviolet curing device of the present disclosure, the first curing module and the second curing module are disposed at the two sides of the to-be-cured display panel, respectively.

In the ultraviolet curing device of the present disclosure, both of the first curing module and the second curing module comprise: a light emitting assembly configured to emit the ultraviolet rays; an adjusting assembly connected to the light emitting assembly and configured to adjust directions of the ultraviolet rays to make the ultraviolet rays reach the to-be-cured display panel at the specific angle.

In the ultraviolet curing device of the present disclosure, the light emitting assembly comprises a light box, and a light source and a reflection plate disposed inside the light box; the reflection plate configured to reflect the ultraviolet rays emitted from the light source toward an inner side of the light box, to the to-be-cured display panel.

In the ultraviolet curing device of the present disclosure, the reflection plate is made of a heat-resistant material.

In the ultraviolet curing device of the present disclosure, the heat-resistant material is metal.

In the ultraviolet curing device of the present disclosure, the sample stage is a conveyor belt for transmitting the to-be-cured display panel along a horizontal direction.

The present disclosure further provides an ultraviolet curing device, comprising: a sample stage configured to support and fix a to-be-cured display panel; and a curing module disposed above the sample stage and configured to emit ultraviolet rays to make the ultraviolet rays irradiate the to-be-cured display panel at a specific angle; wherein the curing module comprises a first curing module and a second curing module, and the first curing module and the second curing module are disposed symmetrically to cure the to-be-cured display panel at two sides thereof at the same time.

In the ultraviolet curing device of the present disclosure, the curing module further comprises a control module connected to the first curing module and the second curing module and configured to control the first curing module and the second curing module to irradiate the to-be-cured display panel at the specific angles with the ultraviolet rays.

In the ultraviolet curing device of the present disclosure, the first curing module and the second curing module are disposed at the two sides of the to-be-cured display panel, respectively.

In the ultraviolet curing device of the present disclosure, both of the first curing module and the second curing module comprise: a light emitting assembly configured to emit the ultraviolet rays; an adjusting assembly connected to the light emitting assembly and configured to adjust directions of the ultraviolet rays to make the ultraviolet rays reach the to-be-cured display panel at the specific angle.

In the ultraviolet curing device of the present disclosure, the light emitting assembly comprises a light box, and a light source and a reflection plate disposed inside the light box; the reflection plate configured to reflect the ultraviolet rays emitted from the light source toward an inner side of the light box, to the to-be-cured display panel.

In the ultraviolet curing device of the present disclosure, the reflection plate is made of a heat-resistant material.

In the ultraviolet curing device of the present disclosure, the heat-resistant material is metal.

In the ultraviolet curing device of the present disclosure, the curing module is configured to move along a specific path back and forth.

In the ultraviolet curing device of the present disclosure, the sample stage is a conveyor belt for transmitting the to-be-cured display panel along a horizontal direction.

In the ultraviolet curing device of the present disclosure, the curing module is disposed above the to-be-cured display panel and is configured to emit the ultraviolet rays and make the ultraviolet rays irradiate the to-be-cured display panel at a specific angle. The curing module includes a first curing module and a second curing module. The first curing module and the second curing module are disposed symmetrically. In such a way, the to-be-cured display panel can be cured at the two sides thereof at the same time. The curing efficiency is increased. Also, the ultraviolet rays irradiated at specific angles can reach the to-be-cured display panel at the two sides thereof. In such a way, curing at the two sides of the to-be-cured display panel 30 is better carried out, thereby improving the quality of the display panel.

To make above content of the present invention more easily understood, it will be described in details by using preferred embodiments in conjunction with the appending drawings.

### BRIEF DESCRIPTION OF THE DRAWINGS

The technical schemes and other beneficial effects will be more apparent with reference to the detailed descriptions of the embodiments of the present invention below in accompanying with the drawings.

FIG. 1 is a schematic structural diagram illustrating an ultraviolet curing device provided in accordance with a preferred embodiment of the present disclosure.

FIG. 2 is a schematic structural diagram illustrating a first curing module and a second curing module of an ultraviolet curing device provided in accordance with a preferred embodiment of the present disclosure.

### DETAILED DESCRIPTION OF THE DISCLOSURE

To further illustrate the technical schemes adopted in the present disclosure and their corresponding effects, preferred embodiments of the present disclosure will be described in detail with reference to the appending drawings. Obviously, the embodiments described herein are a part rather than all of the embodiments of the present disclosure. All other embodiments obtained by a person of ordinary skill in the art based on the embodiments of the present disclosure without creative efforts shall fall within the scope of the present disclosure.

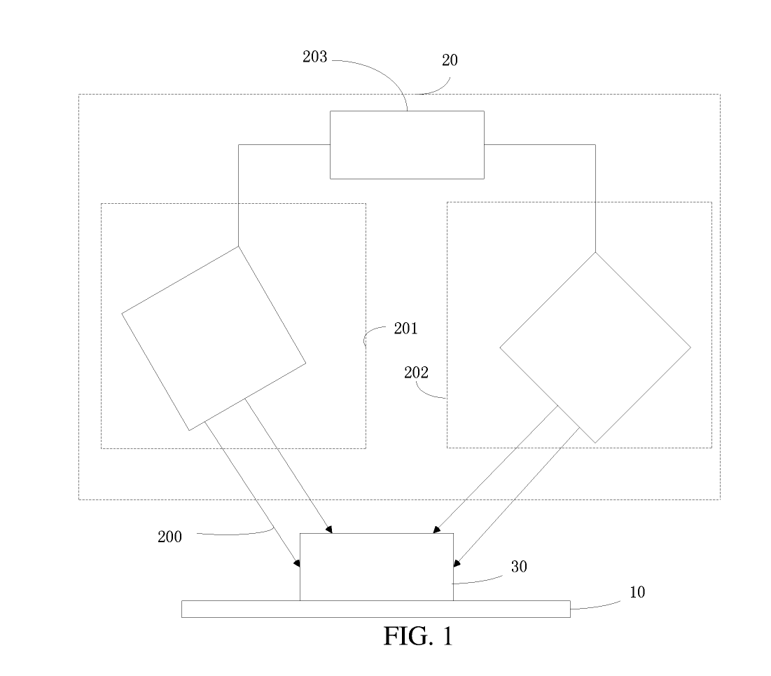

FIG. 1 is a schematic structural diagram illustrating an ultraviolet curing device provided in accordance with a preferred embodiment of the present disclosure. As shown in FIG. 1, the ultraviolet curing device provided in the present preferred embodiment includes a sample stage 10 and a curing module 20. The sample stage 10 is configured to support and fix a to-be-cured display panel 30. The curing module 20 is disposed above the sample stage 10 and is configured to emit ultraviolet rays 200 to make the ultraviolet rays 200 irradiate the to-be-cured display panel 30 at a specific angle.

In the ultraviolet curing device of the present disclosure, the ultraviolet rays 200 emitted from the curing module 20 are irradiated at specific angles and reach the to-be-cured display panel 30 at different positions. For example, in order to curing the to-be-cured display panel 30 from two sides thereof, the ultraviolet rays 200 can be irradiated at specific angles to reach the two sides of the to-be-cured display panel 30. In such a way, curing at the two sides of the to-be-cured display panel 30 is better carried out, thereby improving the quality of the display panel.

Further, the curing module 20 includes a first curing module 201 and a second curing module 202. The first curing module 201 and the second curing module 202 are disposed at the two sides of the to-be-cured display panel 30, respectively, and are disposed symmetrically such that the to-be-cured display panel 30 can be cured at the two sides thereof at the same time. For example, in curing the to-be-cured display panel 30, the ultraviolet rays 200 can be irradiated at a specific angle by controlling the first curing module 201 to cure the to-be-cured display panel 30 at one side thereof. It is noted that the specific angle can be selected as needed, and the present disclosure is not limited thereto. That is, the selection of the specific angle is intended to make one side of the edge of to-be-cured display panel 30 sufficiently cured. Meanwhile, the ultraviolet rays 200 can be irradiated at a specific angle by controlling the first curing module 202 to cure the to-be-cured display panel 30 at the other side thereof. Similarly, the specific angle can be selected as needed, and the present disclosure is not limited thereto. That is, the selection of the specific angle is intended to make the other side of the edge of to-be-cured display panel 30 sufficiently cured.

In addition, the curing module further includes a control module 203 connected to the first curing module 201 and the second curing module 202. The control module 203 is configured to control the first curing module 201 and the second curing module 202 to irradiate the ultraviolet rays 20 to the to-be-cured display panel 30 at specific angles. For example, in curing the to-be-cured display panel 30, the control module 203 outputs a first control signal to the first curing module 201 and outputs a second control signal to the second curing module 202. The first control signal makes the first curing module 201 move to a location near one edge side of the to-be-cured display panel 30 as well as makes the first curing module 201 cure the to-be-cured display panel 30 at one side thereof at a specific angle. The second control signal makes the second curing module 202 move to a location near the other edge side of the to-be-cured display panel 30 as well as makes the second curing module 202 cure the to-be-cured display panel 30 at the other side thereof at a specific angle.

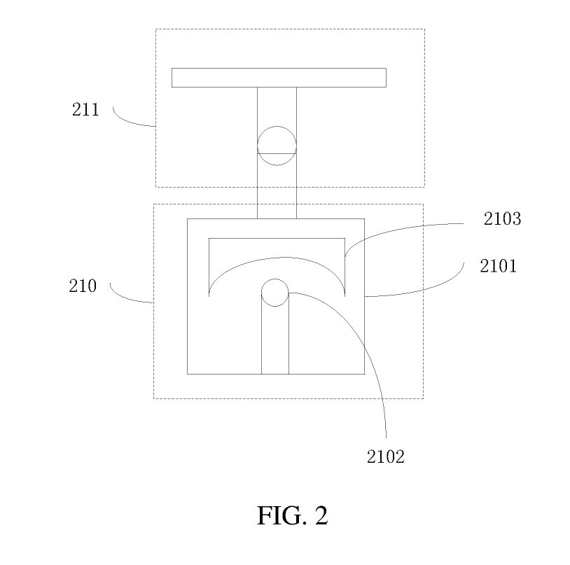

FIG. 2 is a schematic structural diagram illustrating a first curing module and a second curing module of an ultraviolet curing device provided in accordance with a preferred embodiment of the present disclosure.

Specifically, as shown in FIGS. 1 and 2, both of the first curing module 201 and the second curing module 202 includes a light emitting assembly 210 and an adjusting assembly 211. The light emitting assembly 210 is configured to emit the ultraviolet rays 210. The adjusting assembly 211 is connected to the light emitting assembly 210 and is configured to adjust the directions of the ultraviolet rays 200 to make the ultraviolet rays reach the to-be-cured display panel 30 at a specific angle.

Further, the light emitting assembly 210 includes a light box 2101, and a light source 2102 and a reflection plate 2103 disposed inside the light box 2101. The reflection plate 2103 is disposed above the light source 2102 and is configured to reflect the ultraviolet rays 200 emitted from the light source 2102 toward an inner side of the light box 210, to the to-be-cured display panel 300. Preferably, the reflection plate 2103 is made of a heat-resistant material in order not to be affected by the heat emanated from the light source 2102. The heat dispersing material may be implemented by metal.

In order to increase the curing efficiency of the ultraviolet curing device of the present disclosure, the sample stage 10 of the present preferred embodiment can be implemented by a conveyor belt for transmitting the to-be-cured display panel 30 along a horizontal direction. Specifically, the to-be-cured display panel 30 can be transmitted to a position right below the curing module by the conveyor belt when a curing process is performed using the ultraviolet curing device of the present disclosure. After the display panel is cured, the cured display panel is transmitted along with the conveyor belt and is transmitted to a back-end area. Then, a next to-be-cured display panel is transmitted to a position below the curing module. In such a way, the efficiency is further improved.

In addition, in order to prevent some regions of the to-be-cured display panel from being cured insufficiently, the curing module 20 can be configured to move along a specific path back and forth. For example, in curing the to-be-cured display panel 30 at one side thereof using the first curing module 201, the specific path can be set from one edge side to a middle portion of the to-be-cured display panel 30. By using the control module 203, the first curing module 201 can be controlled to move back and forth along such a specific path, such that the to-be-cured display panel 30 are uniformly cured everywhere, similarly, in curing the to-be-cured display panel 30 at the other side thereof using the second curing module 202, the specific path can be set from the other edge side to a middle portion of the to-be-cured display panel 30. By using the control module 203, the second curing module 202 can be controlled to move back and forth along such a specific path, such that the to-be-cured display panel 30 are uniformly cured everywhere.

In the ultraviolet curing device of the present disclosure, the curing module is disposed above the to-be-cured display panel and is configured to emit the ultraviolet rays and make the ultraviolet rays irradiate the to-be-cured display panel at a specific angle. The curing module includes a first curing module and a second curing module. The first curing module and the second curing module are disposed symmetrically. In such a way, the to-be-cured display panel can be cured at the two sides thereof at the same time. The curing efficiency is increased. Also, the ultraviolet rays irradiated at specific angles can reach the to-be-cured display panel at the two sides thereof. In such a way, curing at the two sides of the to-be-cured display panel 30 is better carried out, thereby improving the quality of the display panel.

Above all, while the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An ultraviolet curing device, comprising:
a sample stage configured to support and fix a to-be-cured display panel; and
a curing module disposed above the sample stage and configured to emit ultraviolet rays to make the ultraviolet rays irradiate the to-be-cured display panel at a specific angle;
wherein the curing module comprises a first curing module and a second curing module, and the first curing module and the second curing module are disposed symmetrically to cure the to-be-cured display panel at two sides thereof at the same time;
wherein the curing module further comprises a control module connected to the first curing module and the second curing module and configured to control the first curing module and the second curing module to irradiate the to-be-cured display panel at the specific angles with the ultraviolet rays;
wherein the curing module is configured to move along a specific path back and forth.

2. The ultraviolet curing device according to claim 1, wherein the first curing module and the second curing module are disposed at the two sides of the to-be-cured display panel, respectively.

3. The ultraviolet curing device according to claim 1, wherein both of the first curing module and the second curing module comprise:
a light emitting assembly configured to emit the ultraviolet rays;
an adjusting assembly connected to the light emitting assembly and configured to adjust directions of the ultraviolet rays to make the ultraviolet rays reach the to-be-cured display panel at the specific angle.

4. The ultraviolet curing device according to claim 3, wherein the light emitting assembly comprises a light box, and a light source and a reflection plate disposed inside the light box;
the reflection plate configured to reflect the ultraviolet rays emitted from the light source toward an inner side of the light box, to the to-be-cured display panel.

5. The ultraviolet curing device according to claim 4, wherein the reflection plate is made of a heat-resistant material.

6. The ultraviolet curing device according to claim 5, wherein the heat-resistant material is metal.

7. The ultraviolet curing device according to claim 1, wherein the sample stage is a conveyor belt for transmitting the to-be-cured display panel along a horizontal direction.

8. An ultraviolet curing device, comprising:
a sample stage configured to support and fix a to-be-cured display panel; and
a curing module disposed above the sample stage and configured to emit ultraviolet rays to make the ultraviolet rays irradiate the to-be-cured display panel at a specific angle;
wherein the curing module comprises a first curing module and a second curing module, and the first curing module and the second curing module are disposed symmetrically to cure the to-be-cured display panel at two sides thereof at the same time.

9. The ultraviolet curing device according to claim 8, wherein the curing module further comprises a control module connected to the first curing module and the second curing module and configured to control the first curing module and the second curing module to irradiate the to-be-cured display panel at the specific angles with the ultraviolet rays.

10. The ultraviolet curing device according to claim 9, wherein the first curing module and the second curing module are disposed at the two sides of the to-be-cured display panel, respectively.

11. The ultraviolet curing device according to claim 8, wherein both of the first curing module and the second curing module comprise:
a light emitting assembly configured to emit the ultraviolet rays;
an adjusting assembly connected to the light emitting assembly and configured to adjust directions of the ultraviolet rays to make the ultraviolet rays reach the to-be-cured display panel at the specific angle.

12. The ultraviolet curing device according to claim 11, wherein the light emitting assembly comprises a light box, and a light source and a reflection plate disposed inside the light box;
the reflection plate configured to reflect the ultraviolet rays emitted from the light source toward an inner side of the light box, to the to-be-cured display panel.

13. The ultraviolet curing device according to claim 12, wherein the reflection plate is made of a heat-resistant material.

14. The ultraviolet curing device according to claim 13, wherein the heat-resistant material is metal.

15. The ultraviolet curing device according to claim 8, wherein the curing module is configured to move along a specific path back and forth.

16. The ultraviolet curing device according to claim 8, wherein the sample stage is a conveyor belt for transmitting the to-be-cured display panel along a horizontal direction.
